(19) United States
(12) Patent Application Publication
(10) Pub. No.: US 2012/0165431 A1
(43) Pub. Date: Jun. 28, 2012

(54) COMPOSITION FOR THE PREVENTION/REDUCTION OF MICROBE-INDUCED BIO-CORROSION CAUSED BY SULFATE-REDUCING BACTERIA (SRB) AND OTHER MICROORGANISMS

(76) Inventors: Jörg Leuthäuber, Jena (DE); Torsten Angermann, Jena-Cospeda (DE)

(21) Appl. No.: 13/381,523

(22) PCT Filed: May 27, 2010
(86) PCT No.: PCT/DE10/00633

§ 371 Date: Mar. 15, 2012

(30) Foreign Application Priority Data
Jul. 1, 2009 (DE) 10 2009 031 724.4

(51) Int. Cl. C09D 163/00; C08K 5/36; C09D 5/08

(52) U.S. Cl. 523/453

(57) ABSTRACT

The invention relates to a composition for the prevention/reduction of microbe-induced bio-corrosion caused by sulfate-reducing bacteria (SRB) and other microorganisms, especially for the protection of the inner walls of storage tanks for hydrocarbons of all kinds. The aim of the invention is to devise a composition which protects, when used as a corrosion protection compound, microcracks in the coatings of the inner walls of storage tanks for hydrocarbons of all kinds from anaerobic bio-corrosion in an especially effective manner and for as long a period as possible, owing to a locally defined active protection mechanism (depot effect). The composition comprises an epoxy-based, polymeric, cross-linked Al₂O₃ ceramic particle-containing substrate and a microbistatically effective pyrithione derivative.

The invention relates to a composition for the prevention/reduction of microbe-induced bio-corrosion caused by sulphate-reducing bacteria (SRB) and other microorganisms, especially for the protection of the inner walls of storage tanks for hydrocarbons of all kinds, and to a method for using this composition.

Known corrosion protection layers usually have the task of protecting surfaces from aerobic corrosion. This aerobic corrosion occurs among other things in the upper oxygen-containing phase of filled storage tanks for hydrocarbons of all kinds.

As a matter of principle, it has to be distinguished between this aerobic corrosion in the upper oxygen-containing phase of storage tanks for hydrocarbons of all kinds and the anaerobic corrosion that occurs in many cases in the lower part of the filled tank.

The predominant anaerobic corrosion in the lower part of the filled tank is a microbe-induced bio-corrosion with a corrosion rate of up to 10 times higher compared to the case of aerobic corrosion. Certain types of bacteria are responsible for this anaerobic bio-corrosion, which are grouped together as “sulphate-reducing bacteria” (SRB).

The sulphate-reducing bacteria attack particularly the micro-cracks on the surface of the coated inner wall of storage tanks for hydrocarbons of all kinds, said micro-cracks forming over a longer period of time due to a certain aging of the coating of the interior wall of the tank and distributed throughout by tension forces or other mechanical stresses and strains.

As a basic principle, storage tanks for hydrocarbons of all kinds are being coated at the moment with “ordinary”, i.e. adapted to aerobic conditions, corrosion protection compounds.

It is known that polymer networks based on epoxides exhibit a high barrier effect against O₂-containing water. This barrier effect is significantly increased by a combination with special Al₂O₃ ceramic particles as a filler that have a suitable particle size distribution. This known coating composition is a suitable protective layer against aerobic corrosion for the upper, oxygen-rich region of the inner tank walls (see in this connection: WO/2005/105332 and WO 2007/115649).

For the lower, anaerobic region of the interior tank walls in which exclusively SRB-induced bio-corrosion occurs, this protective coating has provided inadequate protection so far, especially if there are micro-cracks due to a certain aging in the known protective coating.

As the problem of SRB-induced corrosion has been known for some time, it was already suggested in 1982 to add biocides to the epoxy-based coating system [see in this connection: “Study of microbial corrosion in the oil storage tanks”, ONGC Bulletin (1982), 19 (2), 1-8)].

GB 1571901 discloses a double layer for the protection of petroleum storage tanks against SRB corrosion, where the first layer contains a biocide and the second layer is an “ordinary” epoxy resin layer.

Other known biocide-containing protective coatings in corrosion protection have either to serve the purpose of film preservation, thus protecting the layer itself from microbial attack, or as an anti-fouling layer to prevent the unwanted colonization of the hulls of ships (outside walls of ships) with sedentary organisms from flora and fauna such as mussels, barnacles and various algae.

It is known that the broad-spectrum biocide Zn-pyrithione (1-hydroxy-pyridine-2-thione, zinc salt, Mercaptopyridine N-oxide, zinc salt) has a low solubility in water (8 ppm) and it is proven that it can act microbiostatically over a longer period of time against a number of bacterial species (also including a number of SRBs) as a free salt suspended in an aqueous solution. At the same time, the dissolved Zn-pyrithione is physiotoxicologically and ecotoxicologically virtually harmless so that it is incorporated into cosmetics, among other things.

In the use of biocides in epoxy coatings for the prevention of SRB corrosion, the following fundamental phenomena have to be considered: firstly, biocides are usually firmly encapsulated by the epoxy matrix and therefore ineffective. Pure (insoluble) contact biocides do not unfold a long-range effect, which is needed in order also to protect micro-cracks from SRB corrosion.

Soluble (exposed by means of micro-cracks, decapsulated) biocides that unfold a long-range effect are, as it were, washed out and thus more or less rapidly ineffective against microorganisms.

U.S. Pat. No. 6,063,849 discloses anti-fouling coverings that include, among other components, an epoxy resin, Zn-pyrithione and ceramic particles that are coated with aluminium oxide.

It is the object of the present invention to avoid the disadvantages of the state-of-the-art technology by providing a method for the production of an epoxy resin composition containing Zn-pyrithione particles and ceramic particles, and specifying the use of this composition as a corrosion protection compound, wherein this corrosion protection compound protects microcracks in the coatings of the inner walls of storage tanks for hydrocarbons of all kinds from anaerobic bio-corrosion in an especially effective manner and for as long a period as possible, owing to a locally defined active protection mechanism (depot effect).

Furthermore, the present invention shall specify a method for the use of this composition.

These objects are achieved by a method according to the first patent claim and a use according to the third patent claim. Advantageous embodiments of the invention are set forth in the subordinate claims.

The object is thereby achieved by combining a broad-spectrum biocide (Zn-pyrithione) having a low solubility in an appropriate manner with ceramic fillers in an epoxy matrix.

The essence of the invention is to provide a new composition from at least one epoxy-based, polymeric network (e.g. synthetic resin) with added Al₂O₃ ceramic particles as a filler and a microbiostatically effective pyrithione derivative (broad-spectrum biocide with low solubility) as a microbiostatic solvent-free metal coating for the prevention of SRB-induced bio-corrosion on the inner walls of storage tanks for hydrocarbons of all kinds following microscopic damage of the protective layer.

According to the invention, the following behaviour of the coating is thus achieved: When a composition according to the invention is applied to the inner walls of storage tanks for hydrocarbons of all kinds, it is sufficiently effective against anaerobic bacterial corrosion by means of its barrier function, wherein the biocide active substance (Zn-pyrithione crystals) remains encapsulated. Should, over time, micro-cracks then occur in this coating according to the invention, biocide crystals (Zn-pyrithione crystals) will be exposed. These exposed Zn-pyrithione crystals dissolve very slowly and thereby unfold a long-range effect into the gap. The thereby resulting biocide depot effect of the protective coating according to the invention is thus achieved by the extremely low-soluble Zn-pyrithione crystals adhering to the larger ceramic filler particles in an adsorptive manner. Diffusion processes are made possible by water penetrating between the walls of the micro-cracks between the grain boundaries of the ceramic filler, said water originating from the aqueous phase of the storage medium oil or other hydrocarbons contained within the tanks. Due to these diffusion processes, gradually also more distant biocide particles become activated (dissolved) and by means of the existing depot effect, it is possible to achieve long-lasting protection from anaerobic bacteria.

Also lying within the framework of the invention is the feature that a composition according to the invention is inserted into existing damage to a coating, such as cracks in existing inner wall coatings of storage tanks for hydrocarbons of all kinds, wherein this being sufficiently effective there against anaerobic bio-corrosion owing to its barrier function, wherein the biocidal active substance (Zn-pyrithione crystals) remains encapsulated directly after being inserted into the cracks. After that, should alterations in the form of micro-cracks occur at the cracks that have been filled with the composition according to the invention, biocide crystals (Zn-pyrithione) will be exposed. These exposed Zn-pyrithione crystals dissolve very slowly and so unfold the necessary long-range effect as a result of diffusion in the altered micro-cracks. The long-lasting biocidal effectiveness (depot effect) of the composition within the micro-cracks is thus achieved according to the invention by means of combining the low water-soluble biocide crystals (Zn-pyrithione) together with a high share of ceramic filler in the composition according to the invention.

Due to a penetrating of water into the walls of the cracks between the grain boundaries of the ceramic filler from the aqueous phases of the tank storage medium oil or another hydrocarbon of the tank and the thus enabled diffusion processes, gradually also more distant biocide particles become activated and by means of the resulting depot/reservoir effect, it is possible to achieve long-lasting biocidal protection from anaerobic bacteria.

Zinc pyrithione is particularly suitable for this intended application when according to the invention it is brought to a monomodal particle size distribution state with an average particle size of 1 μm to 6 μm and introduced in a predetermined way into the formulation.

It has to be emphasized that according to the invention, this unfolding of the effectiveness in cases of cracking is inseparably linked with the special properties of the whole system. It is only achieved in the case of epoxy-based binding agents (e.g. polyurethane or polyester or similar binding agents), of the Al₂O₃ composition according to the invention and with the Zn-pyrithione prepared according to the invention.

The protective action of the composition according to the invention comes into effect in the case of fresh damage caused by cracks (crack width preferably in the nanometer and micrometer range). As a rule, this damage occurs after the hardened coating has aged by several months. Owing to aging processes, the coating becomes brittle and over a longer period of time this causes cracks to emerge due to naturally occurring tensile stresses following temperature gradients, or due to mechanical stresses and strains such as during cleaning. These microcracks display freshly broken-open surfaces on their inner sides, which then feature the properties according to the invention.

Further advantageous properties of the invention are a solvent-free formulation and the ability to be applied by means of an airless spraying method in one step (single layer).

Zinc pyrithione is, furthermore, physiotoxicologically and ecotoxicologically largely harmless.

The Zn-pyrithione lies preferably within a monomodal particle size distribution with a size-maximum from 1 μm to 6 μm.

The regulation of this particle size distribution takes place preferably in the grinding-base together with the Al₂O₃ particle composition and some binding agent (e.g. glycidyl components of the epoxy binding agent) using a dispersant (with a correspondingly suitable dispersant disk). The total formulation of binding agent, filler, and additives (such as wetting, dispersion, flow-control, and ventilation additives) contains 0.1 to 30% Zn-pyrithione, in particular 2 to 10%.

Al₂O₃ ceramic particles are preferably used as a filler. The type, shape and size distribution of these particles is regulated, for example, as described in WO 2005/105332 and WO 2007/115649. Preferably, this Al₂O₃ composition is used in a range of 30-70 wt % based on the total formulation.

The coating compounds or concentrates contain the ingredients according to the invention in an amount of 30 to 100%, and in addition, where appropriate, 0.001 to 10% of another suitable active substance/biocide, as well as 5 to 99 wt % of a further binding agent, extender and/or cross-linking means, and, where appropriate, desiccants and dyes and pigments as well as further processing agents and additives customarily in use in paint technology.

The formulation of the composition (coating compounds) according to the invention allows the application of a protective layer in an advantageous manner by means of simple airless spraying in one step, said protective layer giving durable protection against SRB attack to the subsurface in case of damage in the micrometer range occurring therein.

The composition according to the invention is also used to coat the inner walls of pipelines for transporting hydrocarbons of all kinds, and for coating the inner walls of bioreactors, in particular for anaerobic fermentation processes.

The invention will subsequently be described in more detail on the basis of the following embodiment.

### EMBODIMENT

Grinding-base consisting of 22% in parts by weight of epoxy binding agent in the form of glycidyl components of the epoxy binding agent, 60% parts by weight of Al₂O₃ ceramic filler, 9% by weight of Zn-pyrithione and 9% by weight of additives are dispersed/ground in the dispersant at 2500 rev/min for so long until a particle size distribution for the Zn-pyrithione with a size of 1 μm to 6 μm results. Thereby, only the crystals of the Zn-pyrithione are crushed. The Al₂O₃ additive serves only as an additional tool for grinding and remains constant. Here, the measuring signals of the static light scattering for the particle size distribution of the Al₂O₃ particle are well separated from the measuring signals of the Zn-pyrithione.

The grinding-base undergoes a final formulation and is thoroughly mixed with the remaining components of the formulation, resulting in an overall composition of 35 wt % of glycid components of the epoxy binding agent, 20 wt % of amine components of the epoxy binding agent, 35 wt % of Al₂O₃ ceramic filler particles, 5 wt % of Zn-pyrithione and 5 wt % of additives.

To demonstrate the effectiveness of the protective layer on the subsurface against SRB attack, suitable samples are coated with the coating according to the invention, said coating then being inflicted with artificial microcracks. These samples are stored under anaerobic conditions for 30 days in a medium that has been inoculated with SRB. The test organisms used were the representative species of SRB Desulfovibrio vulgaris in a pure culture. Due to the then ensuing bio-corrosion, “corrosion hollows (or hutches)” develop. By comparing these different distinct corrosion hollows, conclusions can be drawn about the degree of protection provided by the layer. Protection of 100% is defined when a long-range effect occurs at least 5 μm from the edge of the micro-crack. This result is achieved with the embodiment. All the features depicted in the description, the embodiments and the following claims can be both individually as well as in any combination with each other essential to the invention.

1. Method for the production of a composition for coating the inner walls of storage tanks for hydrocarbons of all kinds comprising at least one epoxy-based Al₂O₃ ceramic particle-containing binding agent and a microbiostatically effective pyrithione derivative in which the Zn-pyrithione crystals are crushed and the Al₂O₃ ceramic particles remain constant in size, and the thus treated grinding-base undergoes a final formulation and is thoroughly mixed with the other ingredients of the composition, so that an overall composition of 35 wt % of glycid components of the epoxy binding agent, 20 wt % amine components of the epoxy binding agent, 35 wt. % Al₂O₃ ceramic filler particles, 5 wt. % of Zn-pyrithione and 5 wt. % of additives results.

2. Method for the production of a composition for coating the inner walls of storage tanks for hydrocarbons of all kinds according to claim 1, characterized in that the grinding-base consists of 22% in parts by weight of glycidyl components of the epoxy binding agent, 60% parts by weight of Al₂O₃ ceramic filler, and 9% by weight of Zn-pyrithione and 9% by weight of additives and is dispersed/ground in the dispersant for so long until a particle size distribution for the Zn-pyrithione with a particle size of 1 μm to 6 μm is reached.

3. Use of a composition for coating the inner walls of storage tanks for hydrocarbons of all kinds comprising at least one epoxy-based Al₂O₃ ceramic particle-containing binding agent and a microbiostatically effective pyrithione derivative as a solvent-free metal coating for the prevention of microbe-induced bio-corrosion on the inner walls of storage tanks for hydrocarbons of all kinds.

4. Use of a composition according to claim 3, characterized in that the composition is applied to the inner walls in one step by means of airless spraying.

5. Use of a composition according to claim 3 or 4, characterized in that the composition is used for the removal of coating damage on the inner walls.

6. Use of a composition for coating the inner walls of storage tanks for hydrocarbons of all kinds comprising at least one epoxy-based Al₂O₃ ceramic particle-containing binding agent and a microbiostatically effective pyrithione derivative as a solvent-free metal coating for the prevention of microbe-induced bio-corrosion on the inner walls of pipelines used for the transport of hydrocarbons of all kinds.

7. Use of a composition for coating the inner walls of storage tanks for hydrocarbons of all kinds comprising at least one epoxy-based Al₂O₃ ceramic particle-containing binding agent and a microbiostatically effective pyrithione derivative as a solvent-free metal coating for the prevention of microbe-induced bio-corrosion on the inner walls of bioreactors.
